(19) United States
(12) Patent Application Publication
(10) Pub. No.: US 2025/0020767 A1
(43) Pub. Date: Jan. 16, 2025

(54) RADAR SENSOR

(71) Applicant: SICK AG, Waldkirch (DE)

(72) Inventors: Matthias KRONAUGE, Waldkirch (DE); Sebastian SCHWARZKOPF, Waldkirch (DE)

(21) Appl. No.: 18/768,670

(22) Filed: Jul. 10, 2024

(30) Foreign Application Priority Data
Jul. 11, 2023 (DE) 102023118328.1

(51) Int. Cl. G01S 7/03; G01S 7/35; G01S 7/40; G01S 13/02

(52) U.S. Cl. CPC G01S 7/032; G01S 13/48

(57) ABSTRACT

A radar sensor has at least one first radar transceiver semiconductor chip and at least one second radar transceiver semiconductor chip. The first radar transceiver semiconductor chip and the second radar transceiver semiconductor chip each have at least two transmission antennas and at least two receiver antennas and a carrier frequency. The first radar transceiver semiconductor chip and the second radar transceiver semiconductor chip have a common control and evaluation unit, with the control and evaluation unit being configured to control and evaluate the respective transmission antennas and receiver antennas of the first and second radar transceiver semiconductor chips, with the carrier frequencies between the radar transceiver semiconductor chips not being synchronized. The first radar transceiver semiconductor chip and the second radar transceiver semiconductor chip do not have any common radio frequency basis.

The present invention relates to a radar sensor.

The present invention relates to a radar sensor having a high angular resolution.

Using radar sensors, objects in a detection zone can be detected and their relative positions can be measured at distances and angles from the sensor. A radial speed can also be measured, for example.

To measure the relative position and angle, electromagnetic signals are transmitted by the radar sensor and their reflections at objects, that is echoes, are received again and evaluated.

A plurality of spatially distributed transmission and reception antennas are used for the angle measurement and the phasing of the received echo signal at the spatially distributed antennas is compared to thus draw a conclusion on the angle. The more transmission and reception antennas that are used, the better the angular resolution.

Three important basic terms or abbreviations that are known and important from the field will be explained here for reasons of completeness.

Systems having a single transmission antenna (input) and a plurality of reception antennas (output) are called single input multiple output (SIMO) systems.

Systems having a plurality of transmission antennas and a single reception antenna are called multiple input single output (MISO) systems.

Systems having a plurality of transmission antennas and a plurality of reception antennas are called multiple input multiple output (MIMO) systems.

It is generally possible to use one transmission antenna and a plurality of reception antennas, or conversely one reception antenna and a plurality of transmission antennas; the result is the same in content. The different arrangements may differ in the costs for the hardware on the transmission and reception side.

If more antennas are required than available with one radar transceiver, there is the possibility of arranging a plurality of radar transceiver chips. Every transmission antenna of every radar transceiver chip can then be combined with every reception antenna of every radar transceiver chip. Starting from an example of one radar transceiver chip having 3 transmission antennas and 4 reception antennas, there would therefore be with e.g. two radar transceiver chips, six transmission antennas and eight reception antennas, that is 6×8=48 virtual antennas with only fourteen (2×(3+4)) individual physical antennas.

So that the signal of a transmission antenna of a radar transceiver chip can be received by a reception antenna of a different radar transceiver chip, it is, however, necessary to synchronize a carrier frequency (for example 60 GHZ) between the two radar transceiver chips. This is very complex since a very high frequency has to be transmitted over a line between the two radar transceiver chips. A complex radio frequency synchronization line between the radar transceiver chips would be required for this purpose.

In addition, the hardware and/or electronics effort for such a system is very high since antennas for these high frequencies have to be developed and then produced with very exact dimensions on expensive special radio frequency material.

An object of the invention comprises providing an improved and less expensive radar sensor that uses a plurality of spatially distributed transmission antennas and reception antennas and compares the phasing of the received echo signal at the spatially distributed antennas to thus draw a conclusion on the angle.

The object is satisfied by a radar sensor having at least one first radar transceiver semiconductor chip and at least one second radar transceiver semiconductor chip, wherein the first radar transceiver semiconductor chip has at least two transmission antennas and at least two receiver antennas, wherein the second radar transceiver semiconductor chip has at least two transmission antennas and at least two receiver antennas, wherein every radar transceiver semiconductor chip respectively has a carrier frequency, wherein the first radar transceiver semiconductor chip and the second radar transceiver semiconductor chip have a common control and evaluation unit, with the control and evaluation unit being configured to control and evaluate the transmission antennas and receiver antennas of the first radar transceiver semiconductor chip and the control and evaluation unit being configured to control and evaluate the transmission antennas and receiver antennas of the second radar transceiver semiconductor chip, with the carrier frequencies between the radar transceiver semiconductor chip not being synchronized, whereby the first radar transceiver semiconductor chip and the second radar transceiver semiconductor chip do not have any common radio frequency basis (respectively no common high frequency basis).

The radar transceiver semiconductor chip can synonymously also be called a radar transceiver semiconductor component.

Multiple input multiple output (MIMO) systems, according to which a plurality of transmission antennas and a plurality of reception antennas are provided, are advantageous in accordance with the invention because every transmission antenna can be combined with every reception antenna to form a virtual antenna.

The radar transceiver semiconductor chip, for example, has two, three, four, five, six, seven, or more transmission antennas. The radar transceiver semiconductor chip, for example, has two, three, four, five, six, seven, or more reception antennas. In this respect, the number of transmission antennas and the number of reception antennas may differ.

The radar transceiver semiconductor chip, for example, has three transmission antennas and four reception antennas—that is a total of seven physical antennas. The combination of every transmission antenna with every reception antenna, that is three times four, thus produces twelve virtual antennas that can be evaluated in exactly the same way as twelve physically present antennas. The hardware effort and/or electronics effort for the transmission antennas and reception antennas, and additionally construction size, are thus saved.

There is, for example, a radar transceiver semiconductor chip suitable for the invention of IWR6843AOP of Texas Instruments for e.g. 60 GHZ, with the antennas already being arranged on the chip package with, for example, three transmission antennas and four reception antennas. The big advantage is that no radio frequency design on a circuit board and no separate antenna development are required.

In accordance with the invention, at least two such or similar radar transceiver semiconductor chips are combined without synchronizing them.

Without the synchronization, the possibility is admittedly dispensed with of receiving the signal of a transmission antenna of the one radar transceiver semiconductor chip by a reception antenna of the other radar transceiver semiconductor chip. The received signals of all the antennas can nevertheless be coherently processed with one another by the control and evaluation unit. This point is essential to the present invention. With two radar transceiver semiconductor chips, eight virtual channels would thus be possible with a respective two transmission antennas and two reception antennas per radar transceiver semiconductor chip (2 transmission antennas×2 reception antennas×2 radar transceiver semiconductor chips) or, for example, twenty four virtual channels with three transmission antennas and four reception antennas per radar transceiver semiconductor chip (3 transmission antennas×4 reception antennas×2 radar transceiver semiconductor chips).

That is fewer than the 16 (4 transmission antennas×4 reception antennas) or 48 (6 transmission antennas×8 reception antennas) possible virtual antennas from all the combinations with two radar transceiver semiconductor chips, but is in turn achievable without any radio frequency design between the radar transceiver semiconductor chips. Development effort is thereby saved; the system is kept very simple and the manufacturing costs are limited and more relatively high angular resolution is simultaneously made possible for a radar sensor.

A complex synchronization line suitable for radio frequency between the radar transceiver semiconductor chips is thus dispensed with. Such a synchronization line would be complex and expensive in the two-digit GHz range, in particular when radar transceiver semiconductor chips are used that have already integrated the antennas on the semiconductor chip. For then a radio frequency synchronization line would only be required for the synchronization of the radar transceiver semiconductor chip.

In accordance with the invention, no synchronization takes place between the radar transceiver semiconductor chips. It is thus admittedly not possible to combine the transmitters of the one radar transceiver semiconductor chip with the receivers of the other radar transceiver semiconductor chip. Unlike above there are then with e.g. two radar transceiver semiconductor chips each having, for example, three transmission antennas and four reception antennas (3 transmission antennas×4 receiver antennas)+(3 transmission antennas×4 receiver antennas))=24 received signals or 24 combined antennas.

Even if these twenty four combined antennas or received signals may not have the same RF basis, they can, however, nevertheless be compared with one another in their phasing in order thus to resolve in the angle from a virtual array of 24 elements. For example, via an applied fast Fourier transform (FFT) over all, for example, twenty four combined antennas or received signals.

In accordance with the invention, the radar sensor is simply scalable in the development. For example, not only two radar transceiver semiconductor chips are used, but rather in principle as many as necessary, that is also a plurality or a multiplicity of radar transceiver semiconductor chips that are combined.

A relatively high angular resolution of the radar sensor is thus achieved with less development effort substantially smaller manufacturing costs, and a small construction size.

The spatial positioning of the radar transceiver semiconductor chips with respect to one another is important, for example. The arrangement and positioning of the radar transceiver semiconductor chips or of the transmission antennas and reception antennas on the radar transceiver semiconductor chip decides how much angular resolution is achieved in the horizontal and vertical directions.

A radar sensor having a plurality of transmission antennas and a plurality of reception antennas is provided, for example. A received signal is obtained for every combination of transmission antenna and reception antenna. In accordance with the following example, 3 transmission antennas and 4 reception antennas produce 12 received signals.
Transmission antenna one transmits, reception antenna one receives: received signal one;
Transmission antenna one transmits, reception antenna two receives: received signal two;
Transmission antenna one transmits, reception antenna three receives: received signal three; Transmission antenna one transmits, reception antenna four receives: received signal four;
Transmission antenna two transmits, reception antenna one receives: received signal five;
Transmission antenna two transmits reception antenna two receives: received signal six;
Transmission antenna two transmits, reception antenna three receives: received signal seven;
Transmission antenna two transmits, reception antenna four receives: received signal eight;
Transmission antenna three transmits, reception antenna one receives: received signal nine;
Transmission antenna three transmits, reception antenna two receives: received signal ten;
Transmission antenna three transmits, reception antenna three receives: received signal eleven;
Transmission antenna three transmits, reception antenna four receives: received signal twelve.

If the transmission antennas and reception antennas are arranged areally, a virtual array is produced with the twelve received signals that corresponds in all properties with exactly one phased array having a single transmission antenna and twelve reception antennas. The signals can accordingly be evaluated in exactly the same way as in a classical phased array. In a phased array, the phasing of the signals are compared with one another to thus be able to draw a conclusion on the angle. For example with a fast Fourier transform (FFT) over all the received signals.

A phased array antenna is a phased group antenna having a strong directivity that achieves a bundling of the radiation energy by the arrangement and interconnection of individual radiators. If the individual radiators can be differently controlled, the antenna diagram of the antenna is electronically pivotable (electronic beam pivoting).

The signal received by the radar sensor or radar unit is basically a time sequence of pulses whose amplitudes and phases can be measured. The Doppler frequency processing is additionally based on a measurement of the portion of the frequency spectrum of the received signal. The frequency portion of the time related signal is determined by the Fourier transform.

The Fourier transform has become a fundamental process in signal processing since a plurality of pieces of information in the signal shape are contained with a radar echo. These pieces of information are converted into a data format by the Fourier transform that can be utilized by the computer aided further processing in the control and evaluation unit.

A fast Fourier transform is an algorithm by which the discrete Fourier transform can be carried out more quickly and efficiently. This is achieved by:
the choice of a sufficiently suitable mathematical algorithm;
the avoidance of multiplications (they last a great deal longer on the computer than additions);
the technical software possibility in the control and evaluation unit of already being able to provide the first values as approximations already during the calculation.

Due to these measures, a fast Fourier transform often requires fewer than a hundredth of the computing time of a discrete Fourier transformation (depending on the number of samples). Whole signal shapes of radar echoes can be stored as only a few data using the fast Fourier analysis in the automatic object recognition.

The Fourier transform is a form of analysis that breaks down a function into sine and cosine components (basis functions) that is into a sum of sine or cosine functions of different frequency, phase and amplitude. This analysis is called a discrete Fourier transform (DFT) to distinguish it from the fast Fourier transform.

The transmission antenna and receiver antenna have to be synchronous RF-wise to be able to receive the echo signal related to the signal transmitted by a transmission antenna with any desired reception antenna. In pulse radar, they need the same local oscillator; in FMCW radar, the instantaneous transmission signal has to be present at the receiver.

On a use of only one single radar transceiver semiconductor chip, the synchronization takes place internally on the radar transceiver semiconductor chip. If the number of transmitters and receivers is now to be further increased, a limit is eventually reached that a single chip never provides an arbitrary number of transmitters and receivers. In accordance with the invention, two or more radar transceiver semiconductor chips are then used to further enlarge the virtual array and to increase the angular resolution.

In a further development of the invention, the first radar transceiver semiconductor chip and the second radar transceiver semiconductor chip are cascaded and the control and evaluation unit is integrated in at least one radar transceiver semiconductor chip.

If the radar transceiver semiconductor chips in accordance with the further development include the signal processing, that is the control and evaluation unit (e.g. a digital signal processor (DSP) in addition to the analog transmission and reception structures), each radar transceiver semiconductor chip per se itself calculates the signal processing as if it were alone, except for the angle evaluation. In an FMCW (frequency modulated continuous wave) radar system, that would generally be a range fast Fourier transform and a Doppler fast Fourier transform and subsequently a constant false alarm rate (CFAR) detection (separating peaks in the signal from noise). A list of targets or detected objects then results in every radar transceiver semiconductor chip with the distance and radial speed (Doppler frequency) and a complex amplitude.

One of the radar transceiver semiconductor chips is now, for example, the master and collects the object lists or target lists of all the other radar transceiver semiconductor chips (e.g. via a serial peripheral interface (SPI)). A fast Fourier transform is then calculated over all the complex amplitudes (one fast Fourier transform over 24 complex received signals, for example) for every object that was detected by all the radar transceiver semiconductor chips (same distance and radial speed). A final high resolution angle for each detected object results from this.

The interconnection between the radar transceiver semiconductor chips is only a communication interface for data exchange. No other interconnection is required between the radar transceiver semiconductor chips.

In a further development of the invention, the first radar transceiver semiconductor chip and the second radar transceiver semiconductor chip are connected to the common control and evaluation unit.

In accordance with the alternative further development, the control and evaluation unit and/or the signal processing is/are arranged outside the individual radar transceiver semiconductor chips centrally in the control and evaluation unit. The control and evaluation unit is, for example, a digital signal processor. A constant false alarm rate (CFAR) detection is, for example, only carried out after the angle fast Fourier transform. The factor of the length of the fast Fourier transform (e.g. factor 24) to a signal-to-noise ratio would then again be acquired with the last fast Fourier transform and thus a greater range and/or sensitivity over small objects would be obtained.

In a further development of the invention, the radar transceiver semiconductor chips are electronically connected in series.

One of the radar transceiver semiconductor chips is here the master and collects the object lists or target lists of all the other radar transceiver semiconductor chips (e.g. over a serial peripheral interface (SPI)).

The interconnection between the radar transceiver semiconductor chips is only a communication interface for data exchange. No other interconnection is required between the radar transceiver semiconductor chips.

In a further development of the invention, the control and evaluation unit is configured to evaluate the transmission antenna and receiver antenna for an angle evaluation.

An evaluation takes place as described above either first individually in every radar transceiver semiconductor chip and after a range fast Fourier transform, a Doppler fast Fourier transform, and a constant false alarm rate (CFAR) detection, a summation of all the results takes place by the control and evaluation unit and a transmission over e.g. a serial peripheral interface (SPI) into a control and evaluation unit as the master radar transceiver semiconductor chip in which then the angle fast Fourier transform is calculated over all the objects. Or all the radar transceiver semiconductor chips calculate centrally and the detection then only takes place after all the fast Fourier transforms (range Doppler angle).

In a further development of the invention, at least three radar transceiver semiconductor chips are arranged, with the radar transceiver semiconductor chips being arranged geometrically areally in a plane.

For example, four or more radar transceiver semiconductor chips can also be arranged. The more antennas or the larger the antenna system, the more angular resolution is achieved. This is always the advantage since the angular resolution is improved. A division to angular resolution in the horizontal and/or vertical directions is possible with different geometrical arrangements.

In a further development of the invention, the three radar transceiver semiconductor chips are arranged geometrically in matrix form in the horizontal and vertical directions.

For example, four or more radar transceiver semiconductor chips can also be arranged. The more antennas or the larger the antenna system, the more angular resolution is achieved. This is always the advantage since the angular resolution is improved. A division to angular resolution in the horizontal and/or vertical directions is possible with different geometrical arrangements.

The invention will also be explained in the following with respect to further advantages and features with reference to the enclosed drawing and embodiments. The Figures of the drawing show in:

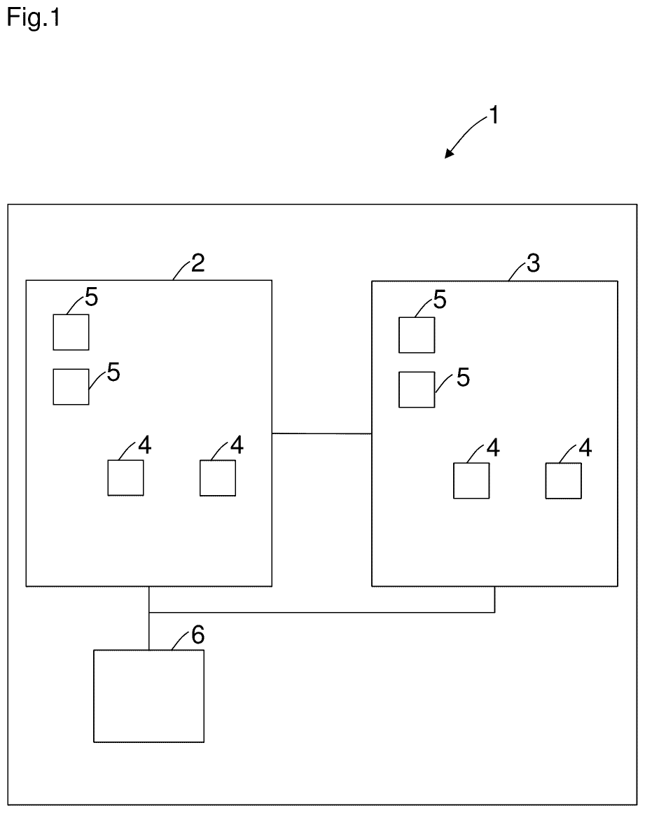

FIG. 1 to FIG. 5 respectively a radar sensor.

In the following Figures, identical parts are provided with identical reference numerals.

FIG. 1 shows a radar sensor 1 having at least one first radar transceiver semiconductor chip 2 and at least one second radar transceiver semiconductor chip 3, wherein the first radar transceiver semiconductor chip 2 has at least two transmission antennas 4 and at least two receiver antennas 5, wherein the second radar transceiver semiconductor chip 2 has at least two transmission antennas 4 and at least two receiver antennas 5, wherein every radar transceiver semiconductor chip 2 respectively has a carrier frequency, wherein the first radar transceiver semiconductor chip 2 and the second radar transceiver semiconductor chip 3 have a common control and evaluation unit 6, with the control and evaluation unit 6 being configured to control and evaluate the transmission antennas 4 and receiver antennas 5 of the first radar transceiver semiconductor chip 2 and the control and evaluation unit 6 being configured to control and evaluate the transmission antennas 4 and receiver antennas 5 of the second radar transceiver semiconductor chip 3, with the carrier frequencies between the radar transceiver semiconductor chips 3 not being synchronized, whereby the first radar transceiver semiconductor chip 2 and the second radar transceiver semiconductor chip 3 do not have any common radio frequency basis.

The radar transceiver semiconductor chip 2, 3, for example, has two, three, four, five, six, seven, or more transmission antennas 4. The radar transceiver semiconductor chip 2, 3, for example, has two, three, four, five, six, seven, or more reception antennas 5. In this respect, the number of transmission antennas 4 and the number of reception antennas 5 may differ.

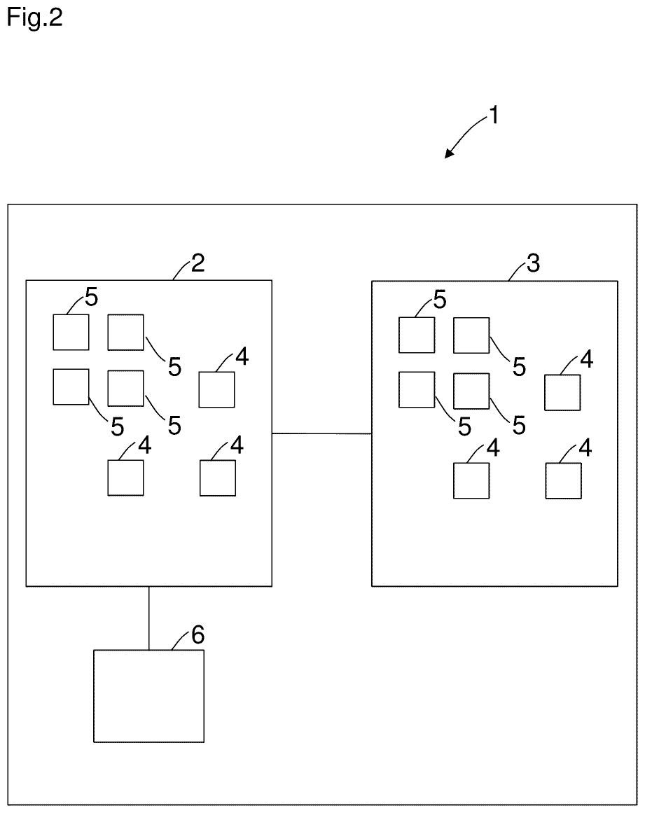

In accordance with FIG. 2, the radar transceiver semiconductor chip 2, 3 has three transmission antennas 4 and four reception antennas 5—that is a total of seven physical antennas. The combination of every transmission antenna 4 with every reception antenna 5, that is three times four, thus produces twelve virtual antennas that can be evaluated in exactly the same way as twelve physically present antennas.

There is, for example, a radar transceiver semiconductor chip suitable for the invention of IWR6843AOP of Texas Instruments for e.g. 60 GHz, with the antennas already being arranged on the semiconductor chip package with, for example, three transmission antennas 4 and four reception antennas 5.

In accordance with FIG. 1 or FIG. 2, at least two such or similar radar transceiver semiconductor chips 2, 3. are combined without synchronizing them.

Without the synchronization, the possibility is admittedly dispensed with of receiving the signal of a transmission antenna 4 of the one radar transceiver semiconductor chip 5 by a reception antenna 5 of the other radar transceiver semiconductor chip 3. The received signals of all the antennas 4, 5, can nevertheless be coherently processed with one another by the control and evaluation unit 6. With two radar transceiver semiconductor chips 2, 3, for example, eight virtual channels would thus be possible with two respective transmission antennas 4 and two reception antennas 5 per radar transceiver semiconductor chip 2, 3. That is two transmission antennas 4 times two reception antennas 5 times two radar transceiver semiconductor chips 2, 3 or, for example, twenty four virtual channels with three transmission antennas 4 and four reception antennas 5 per radar transceiver semiconductor chip 2, 3. That is three transmission antennas 4 times four reception antennas 5 times two radar transceiver semiconductor chips 2, 3.

A complex synchronization line suitable for radio frequency between the radar transceiver semiconductor chips 2, 3 is thus dispensed with. No synchronization thus takes place between the radar transceiver semiconductor chips 2, 3. It is thus admittedly not possible to combine the transmission antennas 4 of the one radar transceiver semiconductor chip 2 with the receiver antennas 5 of the other radar transceiver semiconductor chip 3. Unlike above there are then with e.g. two radar transceiver semiconductor chips 2, 3 each having, for example, three transmission antennas 4 and four reception antennas 5 (three transmission antennas 4 times four receiver antennas 5) plus (three transmission antennas 4 times four receiver antennas) 5)=twenty four received signals or twenty four combined antennas.

Even if these twenty four combined antennas or received signals may not have the same RF basis, they can, however, nevertheless be compared with one another in their phasing in order thus to resolve in the angle from a virtual array of twenty four elements. For example, via an applied fast Fourier transform (FFT) over all, for example, twenty four combined antennas or received signals.

A radar sensor 1 having a plurality of transmission antennas 4 and a plurality of reception antennas 5 is provided, for example. A received signal is obtained for every combination of transmission antenna 4 and reception antenna 5. In accordance with the following example, three transmission antennas 4 and four reception antennas 5 produce twelve received signals.

If the transmission antennas 4 and reception antennas 5 are arranged areally, a virtual array is produced with the twelve received signals that corresponds in all properties with exactly one phased array having a single transmission antenna 4 and twelve reception antennas 5. The signals can accordingly be evaluated in exactly the same way as in a classical phased array. In a phased array, the phasing of the signals are compared with one another to thus be able to draw a conclusion on the angle. For example with a fast Fourier transform (FFT) over all the received signals.

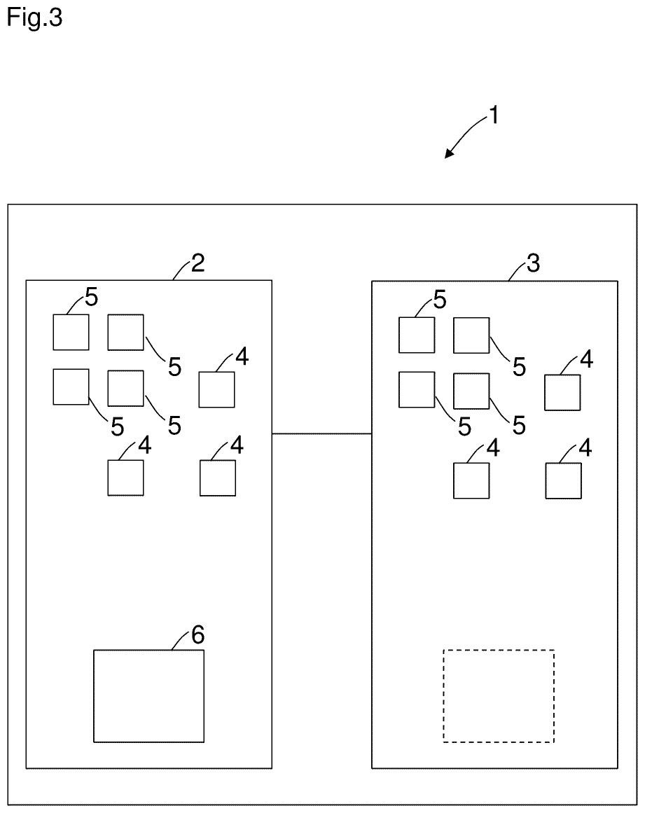

In accordance with FIG. 3, the first radar transceiver semiconductor chip 2 and the second radar transceiver semiconductor chip 3 are cascaded and the control and evaluation unit 6 is integrated in at least one radar transceiver semiconductor chip 2, 3.

If the radar transceiver semiconductor chips 2, 3 in accordance with FIG. 3 include the signal processing, that is the control and evaluation unit 6 (e.g. a digital signal processor (DSP) in addition to the analog transmission and reception structures), each radar transceiver semiconductor chip 2, 3 per se itself calculates the signal processing as if it were alone, except for the angle evaluation. In an FMCW (frequency modulated continuous wave) radar system, that would generally be a range fast Fourier transform and a Doppler fast Fourier transform and subsequently a constant false alarm rate (CFAR) detection (separating peaks in the signal from noise). A list of targets or detected objects then results in every radar transceiver semiconductor chip 2, 3 with the distance and radial speed (Doppler frequency) and a complex amplitude.

One of the radar transceiver semiconductor chips 2, 3 is now, for example, the master and collects the object list or target lists of all the other radar transceiver semiconductor chips 2, 3 (e.g. over a serial peripheral interface (SPI)). A fast Fourier transform is then calculated over all the complex amplitudes (one fast Fourier transform over, for example, 24 complex received signals) for every object, that was detected by all the radar transceiver semiconductor chips 2, 3 (same distance and radial speed). A final high resolution angle for each detected object results from this.

The interconnection between the radar transceiver semiconductor chips 2, 3 is only a communication interface for data exchange. No other interconnection is required between the radar transceiver semiconductor chips 2, 3.

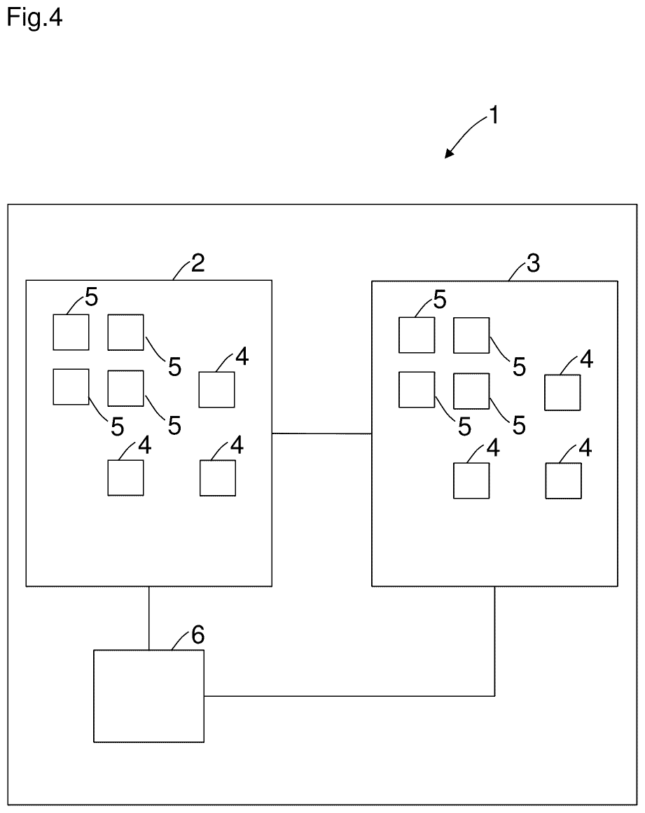

In accordance with FIG. 4, the first radar transceiver semiconductor chip 2 and the second radar transceiver semiconductor chip 3 are connected to the common control and evaluation unit 6.

In accordance with the alternative further development, the control and evaluation unit 6 and/or the signal processing is/are arranged outside the individual radar transceiver semiconductor chips 2, 3 centrally in the control and evaluation unit 6. The control and evaluation unit 6 is, for example, a digital signal processor. A constant false alarm rate (CFAR) detection is, for example, only carried out after the angle fast Fourier transform. The factor of the length of the fast Fourier transform (e.g. factor twenty four) to a signal-to-noise ratio would then again be acquired in the control and evaluation unit 6 with the last fast Fourier transform and thus a greater range and/or sensitivity over small objects would be obtained.

The radar transceiver semiconductor chips 2, 3 are, for example, electronically connected in series.

One of the radar transceiver semiconductor chips 2, 3 is here the master and collects the object lists or target lists of all the other radar transceiver semiconductor chips 2, 3 (e.g. over a serial peripheral interface (SPI)).

The interconnection between the radar transceiver semiconductor chips 2, 3 is only a communication interface for data exchange. No other interconnection is required between the radar transceiver semiconductor chips 2, 3.

The control and evaluation unit 5 is configured, for example, to evaluate the transmission antennas 4 and receiver antennas 5 for an angle evaluation. An evaluation takes place as described above either first individually in every radar transceiver semiconductor chip 2, 3 and after a range fast Fourier transform, a Doppler fast Fourier transform, and a constant false alarm rate (CFAR) detection, a summation of all the results takes place by the control and evaluation unit 6 and a transmission over e.g. a serial peripheral interface (SPI) into a control and evaluation unit 6 as the master radar transceiver semiconductor chip 2, 3 in which then the angle fast Fourier transform is calculated over all the objects. Or all the radar transceiver semiconductor chips 2, 3 calculate centrally and the detection then only takes place after all the fast Fourier transforms (range Doppler angle).

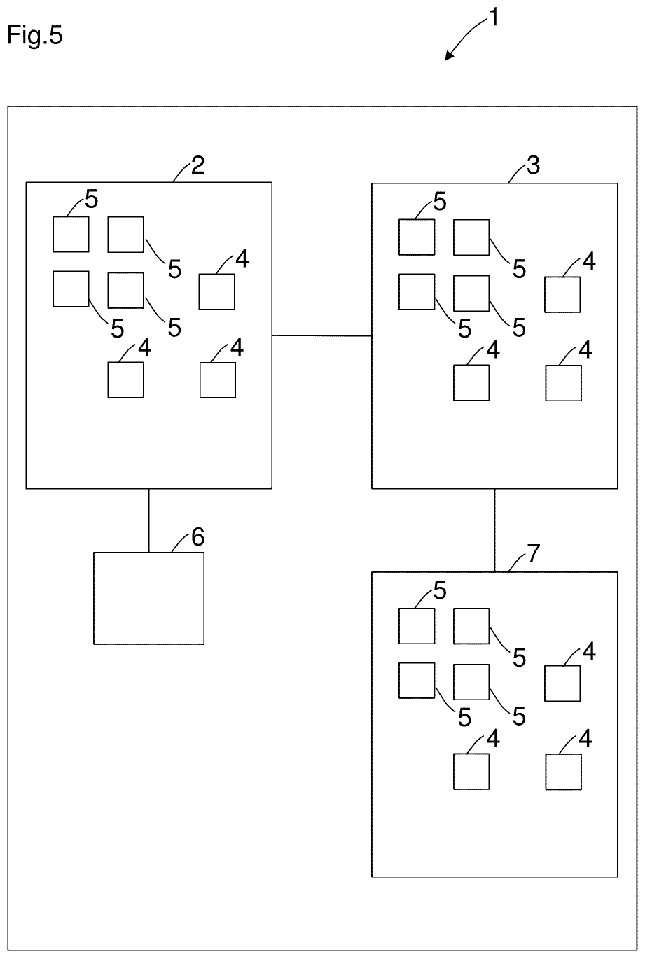

In accordance with FIG. 5, at least three radar transceiver semiconductor chips 2, 3, 7 are arranged, with the radar transceiver semiconductor chips 2, 3, 7 being arranged geometrically areally in a plane.

For example, four or more radar transceiver semiconductor chips 2, 3, 7 can also be arranged. The more antennas or the larger the antenna system, the more angular resolution is achieved. This is always the advantage since the angular resolution is improved. A division to angular resolution in the horizontal and/or vertical directions is possible with different geometrical arrangements.

For example, the three radar transceiver semiconductor chips 2, 3, 7 are arranged geometrically in matrix form in the horizontal and vertical directions.

### REFERENCE NUMERALS

1 radar sensor
2 first radar transceiver semiconductor chip
3 second radar transceiver semiconductor chip
4 transmission antenna
5 receiver antenna
6 control and evaluation unit
7 radar transceiver semiconductor chip

1. A radar sensor having at least one first radar transceiver semiconductor chip and at least one second radar transceiver semiconductor chip,
wherein the first radar transceiver semiconductor chip has at least two transmission antennas and at least two receiver antennas;
wherein the second radar transceiver semiconductor chip has at least two transmission antennas and at least two receiver antennas;
wherein every radar transceiver semiconductor chip respectively has a carrier frequency,
wherein the first radar transceiver semiconductor chip and the second radar transceiver semiconductor chip have a common control and evaluation unit,
with the control and evaluation unit being configured to control and evaluate the transmission antennas and receiver antennas of the first radar transceiver semiconductor chip, and
the control and evaluation unit being configured to control and evaluate the transmission antennas and receiver antennas of the second radar transceiver semiconductor chip, and
with the carrier frequencies between the radar transceiver semiconductor chips not being synchronized,
whereby the first radar transceiver semiconductor chip and the second radar transceiver semiconductor chip have no common radio frequency basis,

2. The radar sensor in accordance with claim 1, wherein the first radar transceiver semiconductor chip and the second radar transceiver semiconductor chip are cascaded and the control and evaluation unit is integrated in a radar transceiver semiconductor chip.

3. The radar sensor in accordance with claim 1, wherein the first radar transceiver semiconductor chip and the second radar transceiver semiconductor chip are connected to the common control and evaluation unit.

4. The radar sensor in accordance with claim 1, wherein the radar transceiver semiconductor chips are electronically connected in series.

5. The radar sensor in accordance with claim 1, wherein the control and evaluation unit is configured to evaluate the transmission antennas and receiver antennas for an angle evaluation.

6. The radar sensor in accordance with claim 1, wherein at least three radar transceiver semiconductor chips are arranged, with the radar transceiver semiconductor chips being arranged areally in a plane.

7. The radar sensor in accordance with claim 6, wherein the three radar transceiver semiconductor chips are arranged geometrically in matrix form in the horizontal and vertical directions.
